(19) United States
(12) Patent Application Publication
(10) Pub. No.: US 2016/0188141 A1
(43) Pub. Date: Jun. 30, 2016

(54) ELECTRONIC DEVICE AND METHOD FOR DISPLAYING TARGET OBJECT THEREOF

(71) Applicant: Wistron Corporation, New Taipei City (TW)

(72) Inventor: Zhao-Yuan Lin, New Taipei City (TW)

(21) Appl. No.: 14/681,118

(22) Filed: Apr. 8, 2015

(30) Foreign Application Priority Data
Dec. 26, 2014 (TW) 103145722

(51) Int. Cl. G06F 3/0484; G06F 3/0481

(52) U.S. Cl. CPC G06F 3/0484; G06F 3/0481

(57) ABSTRACT

An electronic device and a method for displaying a target object thereof are provided. The method includes following steps. Relative position information between the target object and the electronic device is detected. An object display region is calculated according to the relative position information. Whether the object display region overlaps with at least part of a display region on a display unit is determined to obtain a determined result. Tag information of the target object is displayed on a region overlapped by the display region on the display unit and the object display region.

### CROSS-REFERENCE TO RELATED APPLICATION

This application claims the priority benefit of Taiwan application serial no. 103145722, filed on Dec. 26, 2014. The entirety of the above-mentioned patent application is hereby incorporated by reference herein and made a part of this specification.

### BACKGROUND OF THE INVENTION

1. Field of the Invention

The present invention generally relates to a display technique, in particular, to an electronic device and a method for displaying a target object with accurate positioning capability.

2. Description of Related Art

The rapid development in mobile communication technology has resulted in a definite need for electronic devices with a small and portable nature such as smart phones and tabular computers. Various features are integrated in such electronic devices provided in the current market for a competitive advantage. Specifically, the integration between the electronic devices and a mobile communication feature is still in a highly developing stage. The user may be able to track the current position through, for example, an electronic map and a global positioning system (GPS), or may be provided with an optimal guided route to a destination through a navigation system.

However, a conventional electronic map or navigation system may only present current positions of the user and a target object on a map, and yet detailed orientation information therebetween has to be manually compared by the user. Although some existing techniques are capable of rotating an orientation of the electronic devices through a use of the electronic map in conjunction with a positioning feature provided by an electronic compass, they fail to provide a high degree of accuracy and convenience.

### SUMMARY OF THE INVENTION

Accordingly, the present invention is directed to an electronic device and a method for displaying a target object, where the target object may be positioned with accuracy, and the user may be provided with a better visualization.

The present invention is directed to a method for displaying a target object, adapted to an electronic device having a display unit. The method for displaying a target object includes displaying relative position information between the target object and the electronic device, calculating an object display region according to the relative position information, determining whether the object display region overlaps with at least part of a display region on the display unit to obtain a determined result, and displaying tag information of the target on a region overlapped by the display region on the display unit and the object display region according to the determined result.

The present invention is directed to an electronic device. The electronic device includes a display unit, a detecting unit, and a control unit. The control unit is coupled to the display unit and the detecting unit. The detecting unit detects relative position information between a target object and the electronic device. The control unit calculates an object display region according to the relative position information, determines whether the object display region overlaps with at least part of a display region on the display unit to obtain a determined result, and displays tag information of the target on a region overlapped by the display region on the display unit and the object display region according to the determined result.

In view of the foregoing, the electronic device and the method for displaying a target object proposed in the invention utilize global positioning system information to obtain relative position information of the target object respect to the electronic device to calculate an object display region of the target object and provide tag information of the target object according to whether the object display region overlaps with a display region of the display unit. Accordingly, the invention not only accurately positions the target object, but also displays the object display region and the tag information of the target object on the display unit so that the target object may be easily read and perceive by the user with enhanced operating experience.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a block diagram of an electronic device according to an embodiment of the invention.

FIG. 2 illustrates a flowchart of a method for displaying a target according to an embodiment of the invention.

FIG. 3 illustrates an example according to an embodiment of the invention.

FIG. 4 illustrates an example according to an embodiment of the invention.

FIG. 5 illustrates an example according to an embodiment of the invention.

FIG. 6 illustrates an example according to an embodiment of the invention.

### DESCRIPTION OF THE EMBODIMENTS

To accurately position a target object with better visualization, the electronic device and the method for displaying a target object proposed in the invention utilize global positioning system information to calculate relative position information of the target object respect to the electronic device, such as distance information and direction information, to determine an object display region of the target object. Whether the object display region enters a field of view of the electronic device is further determined, and tag information of the target object as well as the portion of the object display region entering the field of view are displayed accordingly. Moreover, the effect of environment information may be considered so as to adjust the positioning of the target object. More particularly, the invention is applicable to wearable devices such as smart watches and smart glasses so that the user may be provided with a better operating experience. Reference will now be made in detail to the present embodiments of the invention, examples of which are illustrated in the accompanying drawings.

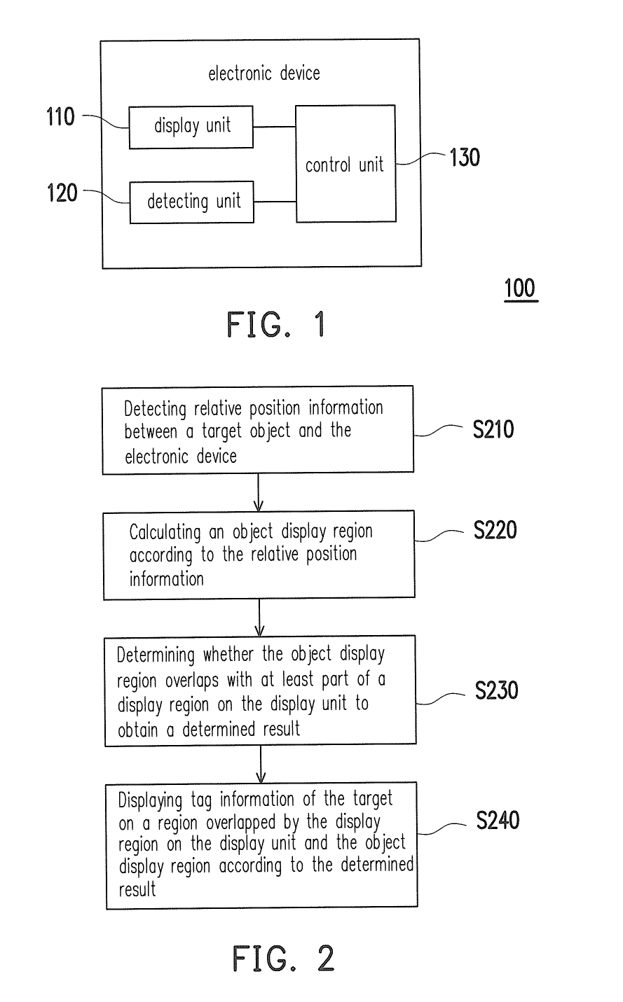

FIG. 1 illustrates a block diagram of an electronic device according to an embodiment of the invention. Referring to FIG. 1, an electronic device 100 may be an electronic device such as a personal computer, a laptop computer, a smart phone, a tabular computer or a personal digital assistant, or may be a wearable device such as a smart watch or smart glasses. The electronic device 100 includes a display unit 110, a detecting unit 120, and a control unit 130, where the functionalities thereof are given as follows.

The display unit 110 may be, for example, a liquid crystal display (LCD), a light-emitting diode (LED) display, a field emission display (FED) or other types of displays. The display unit 110 may be an integration of the aforesaid display and a resistive, capacitive, or optical touch panel, which provides both touch and display features.

The detecting unit 120 may be a detecting component such as a global positioning system component, a G-Sensor, a magnetic inductor such as a magnetometer, an accelerometer, a Gyroscope, or a combination thereof, and yet the invention is not limited thereto. In the present embodiment, the detecting unit 120 is configured to detect, for example, position information and azimuth information of the electronic device 100 in a three-dimensional space.

The control unit 130 is coupled to the display unit 110 and the detecting unit 120. The control unit 130 may be, for example, a single chip, a general-purpose processor, a special-purpose processor, a traditional processor, a digital signal processor (DSP), a plurality of microprocessors, or one or more microprocessors, controllers, microcontrollers, application specific integrated circuit (ASIC), or field programmable gate arrays (FPGA) with a DSP core. The control unit 130 may also be, for example, other types of integrated circuits, a state machine, a processor based on an advanced RISC machine (ARM), or the likes. The control unit 130 is not limited to be a single processing component; it may include two or more processing components executing concurrently. In the present embodiment, the control unit 130 is configured to implement the proposed method for displaying a target object.

Moreover, the electronic device 100 may also include a storage device (not shown), and yet the invention is not limited herein. The storage unit is configured to store data and accessible by the control unit 130. The storage unit may be, for example, a hard disk drive (HDD), a volatile memory, or a non-volatile memory.

FIG. 2 illustrates a flowchart of a method for displaying a target object according to an embodiment of the invention, and is adapted to the electronic device 100 in FIG. 1. Detailed steps of the proposed method will be illustrated along with the components of the electronic apparatus 100 hereafter.

Referring to both FIG. 1 and FIG. 2, in Step S210, the control unit 130 detects relative position information between a target object and the electronic device 100 through the detecting unit 120. To be specific, the relative position information may include distance information and direction information. In an embodiment, the detecting unit 120 may respectively receive global position system information of the target object and the electronic device 100, and the control unit 130 may calculate the relative position information such as a distance and an azimuth between the target object and the electronic device accordingly. In other words, the positioning of the target object and the electronic device 100 may be obtained through the use of a global positioning system.

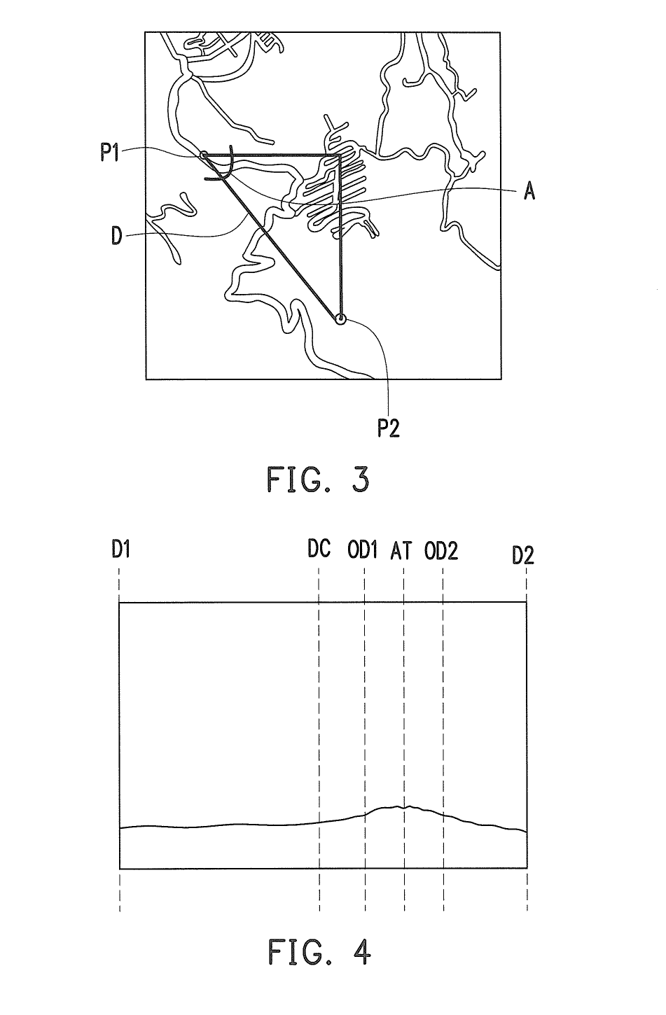

FIG. 3 illustrates an example of an embodiment of the invention. In the embodiment, the detecting unit 120 may obtain a coordinate P1 of the electronic device 100 and a coordinate P2 of the target object in the global positioning system. Next, the control unit 130 may calculate distance information (e.g. a distance D) between the target object and the electronic device 100 according to the coordinates P1 and P2, and further calculate direction information of the target object with respect to the electronic device 100 by using trigonometry (e.g. an angle A of a first direction in which the electronic device 100 faces the target object with respective to a horizontal line). As is well-known to persons skilled in the art, the computation of the distance information and the orientation information derived from the coordinates of the target object and the electronic device 100 will not be illustrated herein.

It should be noted that, the placement of the electronic device 100 may affect the position information of the electronic device 100 in the global positioning system detected by the detecting unit 120. Hence, the control unit 130 may first perform an initial calibration (e.g. through rotation matrix computation) on a coordinate system in which the target object and the electronic device 100 are located so as to calibrate the coordinate system of the electronic device 100.

In Step S220, the control unit 130 calculates an object display region according to the relative position information. To be specific, the object display region may be configured to illustrate a range size of a target object. In an embodiment, the object display region may be determined by the distance between the target object and the electronic device 100. In terms of human visual perception, as the target object becomes more distant, it appears smaller for the user. On the other hand, when the target object becomes less distant, it appears larger for the user. In an embodiment, in order to allow the user to sense how far away the target object is, the control unit 130 may determine a range size of the object display region according to an inverse proportionality between the range size of the object display region and the distance information or according to a difference between the distance information and a predetermined value.

In Step S230, the control unit 130 determines whether the object display region overlaps with at least part of a display region on the display unit 110 to obtain a determined result. In Step S240, the control unit 130 displays tag information of the target on a region overlapped by the display region on the display unit 110 and the object display region according to the determined result. In other words, whether the target object enters a field of view of the electronic device 100 may be determined according to whether the object display region corresponding to the target object overlaps with the display region of the display unit 110. When the object display region overlaps with at least part of the display region on the display unit 110, the control unit 130 may display the tag information of the target object in the overlapped region. The tag information may be a name of the target object or the distance between the target object and the electronic device 100. Moreover, the control unit 130 may display the overlapped region on the display unit 110 in different colors or in other appearances.

Accordingly, through obtaining the global position system information of the target object, configuring the object display region of the target object, and determining whether the object display region overlaps with at least part of the display region on the display unit 110, not only may the target object be positioned accurately, but also the positioning information of the target object may be displayed on the display unit 110. Moreover, the user is allowed to sense how far away the target object is through the range size of the overlapped region in a visualized manner.

It should be noted that, the detecting unit 120 may determine whether the position of the electronic device 100 has been changed through the detection of any variation of movement such as acceleration or angular displacement. Thus, in the present embodiment, the target object may be positioned based on the movement of the electronic device 100 so that the tag information of the target object displayed on the display unit 110 may be continuously updated to allow for dynamic tracking on the target object.

FIG. 4 illustrates an example of an embodiment of the invention, where an image displayed on the display unit 110 through an image drawing procedure is illustrated given that the electronic device 100 is a pair of smart glasses. The electronic device 100 in the present invention may further include an image capturing unit (not shown) coupled to the control unit 130. The image capturing unit is configured to, for example, capture an image scene in front of the electronic device 100 and display the image scene in the display region of the display unit 110.

The electronic device 100 may obtain global position system coordinates of an target object (e.g. a mountain) and the electronic device 100 through a global position system component and obtain an azimuth of the electronic device 100 with respect to the earth through a magnetometer. In such embodiment, based on direction information (e.g. the azimuth) and the transformation between the angle and the display region, the control unit 130 may obtain an object display region and a display region on the display unit 110 through a mapping approach. To be specific, the control unit 130 may calculate a range size, expressed in terms of an angular value, corresponding to the object display region of the target object based on Eq. (1), where OR denotes the range size (e.g. in angular value), and D denotes the distance (e.g. in kilometer) between the target object and the electronic device 100.

OR=60−(D−5) Eq. (1)

Hence, assume that the distance between the target object and the electronic device 100 is calculated to be 45 km by the control unit 130 based on the coordinates thereof. The range size OR is then calculated to be 20° based on Eq. (1).

Next, the control unit 130 may combine the range size OR and the azimuth of the target object so as to obtain the position of the display region on the display unit 110 mapped from the object display region of the target object. For example, boundary angles OD1, OD2 (e.g. in angular values) of the object display region may be determined based on Eq. (2) and Eq. (3), where AT denotes the azimuth of the target object (e.g. in angular value).

OD1=AT+OR/2 Eq. (2)

OD2=AT−OR/2 Eq. (3)

As illustrated in FIG. 4, assume that the azimuth AT of the target object is 115°, the boundary angles OD1 and OD2 of the object display region of the target object are respectively calculated to be 105° and 125° by the control unit 130. In other words, the azimuth of the object display region of the target may be ranged from 105° to 125°.

On the other hand, assume that an azimuth of a center direction DC of the electronic device 100 is 100°. For an ordinary field of view with a range of 100°, the display region of the display unit 110 may be ranged between an boundary angle D1 with 50° and an boundary angle D2 with 150°.

Hence, in the embodiment of FIG. 4, the display region of the target object may overlap the display region of the display unit 110 with an azimuth range from 105° to 125° (i.e. the angular range between the boundary angles OD1 and OD2). The control unit 130 may thus display information such as the name of the mountain (the target object) or the distance 45 km in the overlapped region.

It should be noted that, to determine whether the object display region overlaps with at least part of the display region on the display unit 110, the control unit 130 may configure the boundary angles corresponding to the display region when the object display region enters or leaves the display region of the display unit 110 by, for example, taking the user's field of view into consideration. The control unit 130 may calculate boundary angles B1 and B2 for determining whether the object display region enters or leaves the display region of the display unit 110, where V denotes the user's field of view in angular value.

B1=OD1+V/2 Eq. (4)

B2=OD2−V/2 Eq. (5)

Assume that a user's field of view V is 100. In the present embodiment, the boundary angles B1 and B2 may be 55° and 175° respectively. In other words, as long as the azimuth of the object display region of the target object is within a range between 55° and 175°, the control unit 130 may determine that the object display region of the target object overlaps with at least part of the display region of the display unit 110. That is, the target object enters the field of view, and the control unit 130 may thus display the tag information of the target object.

It should be noted that, in the aforesaid embodiment, the control unit 130 determines how the object display region overlaps with the display region of the display unit 110 based on the azimuth range. In terms of the display frame on the display unit 110, the control unit 130 may output the overlapped region and/or the tag information of the target object on the display unit 110 based on a transformation relationship between pixels and angles. Such transformation relationship may be, for example, the ratio of a pixel to an angle equal to the ratio of a resolution of the display unit 110 to a field of view (i.e. corresponding to the boundary angles D1 and D2), and pixel values of the overlapped region may be calculated thereby.

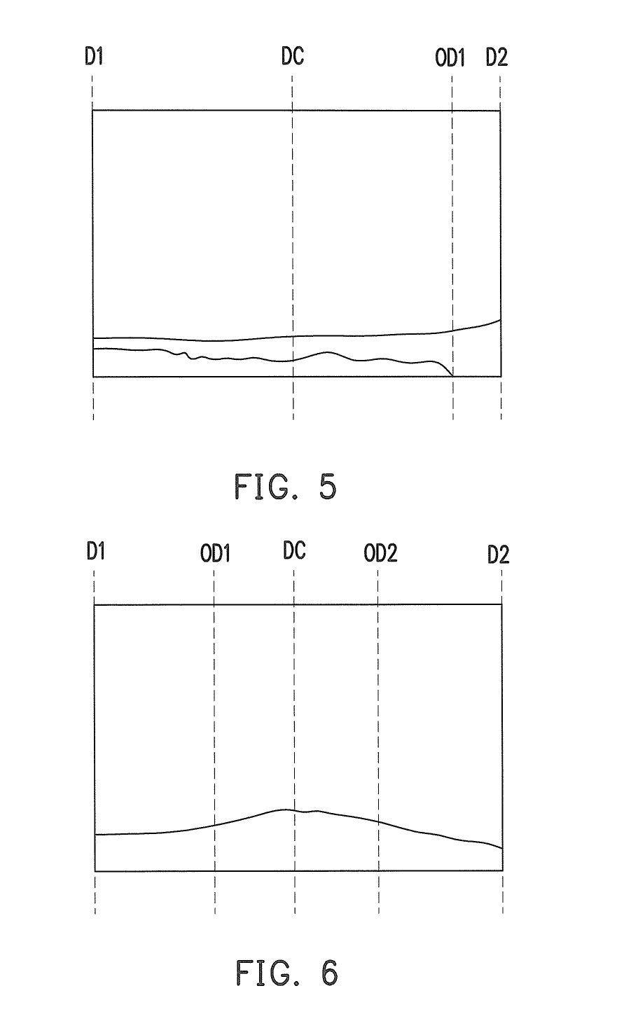

FIG. 5 illustrates an example according to an embodiment of the invention. Referring to FIG. 5, it should be noted that, the present embodiment is similar to the embodiment of FIG. 4. The only difference is that the azimuth of the center direction DC of the electronic device 100 herein is 80°. Meanwhile, assume that the user's field of view V is 100°, and the boundary angles D1 and D2 are 30° and 130° respectively. As previously illustrated, since the object display region is ranged from 105° to 125° (i.e. between boundary angles OD1 and OD2), the object display region of the target object may only overlap with a part of the field of view (i.e. the angle range between the boundary angles OD1 and OD2) in the embodiment of FIG. 5.

FIG. 6 illustrates another example according to an embodiment of the invention. The present embodiment is similar to the aforesaid embodiments. The differences therebetween are that a distance between a target object and the electronic device 100 is 25 km, and the azimuth of the center direction DC of the electronic device is 115° in the present embodiment. Meanwhile, assume that the user's field of view V is 100°, and the boundary angles D1 and D2 are 65° and 165° respectively. Besides, the boundary angles OD1 and OD2 are 95° and 135° respectively. The control unit 130 may calculate that the boundary angles B1 and B2 for determining whether the object display region enters or leaves the display region of the display 110 are 45° and 185° respectively. Hence, in the present embodiment, the display region of the target object may overlap the display region of the display unit 110 with an azimuth range from 95° to 135° (i.e. the angular range between the boundary angles OD1 and OD2). The control unit 130 may thus display information such as the name of the mountain (i.e. the target object) or the distance 45 km in the overlapped region.

In some embodiments, to improve the user experience in the use of the electronic device, the control unit 130 may further determine whether to filter out the related information of the target object by considering the effect of environment information while the user is identifying an target object, where the related information would not be displayed on the display unit 110. The aforesaid environment information may be at least one of altitude, whether condition, distance, or azimuth information, where the altitude information and the distance information may be obtained from the global positioning system information, and the whether condition may be obtained from, for example, a real-time weather information database through a network connection via a communication unit (not shown) of the electronic device 100. Moreover, the azimuth may be obtained by a magnetometer in the detecting unit 120.

A detailed flow of displaying a target object by the control unit 130 according to the environment information will be illustrated hereafter.

To be specific, in an embodiment, the control unit 130 may calculate a distance adjustment parameter according to the environment information and filter out tag information according to whether the distance adjustment parameter is less than a predetermined distance. In the present embodiment, the environment information may be at least one of the altitude and the weather condition.

For example, when considering that the altitude of the electronic device 100 may affect the user's field of view, the control unit 130 may, for example, set 40 km as a basic unit of the field of view and increase the field of view by 2 km whenever the altitude is increased by 100 m. Hence, the field of view may be adjusted adaptively according to the altitude information. Additionally, in terms of the weather condition, the control unit 130 may, for example, increase the field of view by 20 km or 10 km or decrease the field of view by 20 km according to a sunny weather, a cloudy weather, or a rainy weather respectively.

Based on the aforesaid settings, the control unit 130 may determine whether to filter out the tag information of the target object and not to display the tag information based on, for example, Eq. (6) or a threshold such as 40 km, where H and W are the field of views adjusted according to the altitude information and the weather condition and may be expressed in, for example, angle value.

H/100*2+W<40 Eq. (6)

Moreover, in another embodiment, the control unit 130 may further determine whether the target object is blocked according to the azimuth information and the distance information. To be specific, the control unit 130 may calculate a proportion of the region overlapped by the display region to the object display region according to the relative position information and filter out the tag information according to whether the proportion is greater than a predetermined coverage proportion.

For example, in an embodiment, the control unit 130 may set the predetermined coverage proportion to 60% and determine whether to filter out and not to display the tag information of the target object based on Eq. (7), where Az denotes the azimuth (e.g. in angular value) and D denotes the distance (e.g. in kilometer).

10/(Az+D)*100 Eq. (7)

In summary, the electronic device and the method for displaying a target object proposed in the invention utilize global positioning system information to obtain relative position information of the target object respect to the electronic device to calculate an object display region of the target object and provide tag information of the target object according to whether the object display region overlaps with a display region of the display unit. Moreover, the effect of environment information may be considered so as to adjust the positioning of the target object. Accordingly, the invention not only accurately positions the target object, but also displays the object display region and the tag information of the target object on the display unit so that the target object may be easily read and perceive by the user with enhanced operating experience.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for displaying a target object, adapted to an electronic device having a display unit, comprising:
detecting relative position information between a target object and the electronic device;
calculating an object display region according to the relative position information;
determining whether the object display region overlaps with at least part of a display region on the display unit to obtain a determined result; and
displaying tag information of the target on a region overlapped by the display region on the display unit and the object display region according to the determined result.

2. The method according to claim 1, wherein the relative position information comprises distance information and direction information.

3. The method according to claim 2, wherein the step of calculating the object display region according to the relative position information comprises:
calculating the object display region according to an inverse proportionality between a range size of the object display region and the distance information.

4. The method according to claim 2, wherein the step of calculating the object display region according to the relative position information comprises:
determining a range size of the object display region according to a difference between the distance information and a predetermined value.

5. The method according to claim 1, wherein the step of detecting the relative position information comprises:
receiving global positioning system information corresponding to the target object and global positioning system information corresponding to the electronic device to calculate the relative position information.

6. The method according to claim 1, wherein the step of calculating the object display region according to the relative position information comprises:
calculating a distance adjustment parameter according to environmental information, wherein the environmental information comprises at least one of an altitude and a weather condition; and
filtering out the tag information according to whether the distance adjustment parameter is less than a predetermined distance.

7. The method according to claim 1, wherein the step of displaying the tag information of the target on the region overlapped by the display region on the display unit and the object display region according to the determined result comprises:
calculating a proportion of the region overlapped by the display region to the object display region according to the relative position information; and
filtering out the tag information according to whether the proportion is greater than a predetermined coverage proportion.

8. The method according to claim 1 further comprising:
capturing an image scene in front of the electronic device and displaying the image on the display region of the display unit.

9. An electronic device comprising:
a display unit;
a detecting unit, detecting relative position information between a target object and the electronic device; and
a control unit, coupled to the display unit and the detecting unit, calculating an object display region according to the relative position information, determining whether the object display region overlaps with at least part of a display region on the display unit to obtain a determined result, and displaying tag information of the target on a region overlapped by the display region on the display unit and the object display region according to the determined result.

10. The electronic device according to claim 9, wherein the relative position information comprises distance information and direction information.

11. The electronic device according to claim 10, wherein the control unit calculates the object display region according to an inverse proportionality between a range size of the object display region and the distance information.

12. The electronic device according to claim 10, wherein the control unit determines a range size of the object display region according to a difference between the distance information and a predetermined value.

13. The electronic device according to claim 9, wherein the control unit receives global positioning system information corresponding to the target object and global positioning system information corresponding to the electronic device to calculate the relative position information.

14. The electronic device according to claim 9, wherein the control unit calculates a distance adjustment parameter according to environmental information and filters out the tag information according to whether the distance adjustment parameter is less than a predetermined distance, wherein the environmental information comprises at least one of an altitude and a weather condition.

15. The electronic device according to claim 9, wherein the control unit calculates a proportion of the region overlapped by the display region to the object display region according to the relative position information and filters out the tag information according to whether the proportion is greater than a predetermined coverage proportion.

16. The electronic device according to claim 9 further comprising:
an image capturing unit, coupled to the control unit, capturing an image scene in front of the electronic device, and displaying the image on the display region of the display unit.
